(19) United States
(12) Patent Application Publication
(10) Pub. No.: US 2007/0052923 A1
(43) Pub. Date: Mar. 8, 2007

(54) Method for limiting transfer of material between two adjacent polymeric articles

(76) Inventors: Madhu Ayyagari, Fairport, NY (US); David P. Vanderbilt, Webster, NY (US); George E. Diaz, Rochester, NY (US); Christopher E. Wagner, Rochester, NY (US)

Correspondence Address: Bausch & Lomb Incorporated, One Bausch & Lomb Place, Rochester, NY, 14604-2701, US

(21) Appl. No.: 11/219,987

(22) Filed: Sep. 6, 2005

(51) Int. Cl. G02C 7/02

(52) U.S. Cl. 351/177

(57) ABSTRACT

A method for limiting a transfer of an additive in a first polymeric article to a second adjacent polymeric article comprises treating at least a portion of the first article under a condition such that the additive is transformed to a substantially stable phase. A polymeric article comprises a compounded polymeric material that comprises an additive in a base polymeric material, wherein the additive exists in a substantially stable phase.

### BACKGROUND OF THE INVENTION

The present invention relates to a method for limiting the transfer of a material between two adjacent polymeric articles. In particular, the present invention relates to a method for limiting the transfer of a material compounded in one polymeric article to another adjacent polymeric article. More particularly, the present invention relates to a method for limiting the unwanted transfer of a small-molecule material from an apparatus for inserting an intraocular lens (“IOL”) to the IOL during the use of such apparatus.

Many articles are now made of polymeric materials in processes such as molding or extrusion. Typically, small amounts of an additive such as a surfactant, acting as a mold release agent or a lubricant, are added to the polymeric materials to aid in their processing. Such an additive may be undesirably transferred to another article that is in close contact with the first article containing such an additive. A large amount of the transferred additive can contaminate the second article. Thus, it would be advantageous to prevent or at least to limit such unwanted transfer of the additive between the two articles.

Close contact between polymeric surgical apparatuses and medical devices are found in the practice of many surgical procedures, including the implantation of a polymeric IOL in the eye as a replacement for the natural crystalline lens after cataract surgery or to alter the optical properties of (provide vision correction to) an eye in which the natural lens remains. IOLs often include an optic, and preferably at least one flexible fixation member or haptic, which extends from the optic and becomes affixed in the eye to secure the lens in position. The optic normally includes an optically clear lens. Implantation of such IOLs into the eye involves making an incision in the eye. It is advantageous, to reduce trauma and speed healing, to have an incision size as small as possible.

IOLs are known which are foldable (deformable) so that the IOL can be inserted through a smaller incision into the eye. A substantial number of instruments have been proposed to aid in inserting such a foldable lens in the eye. The trend has been to design such instruments with ever smaller inserter tubes to fit in smaller incisions. (The terms “inserter” and “injector” are used interchangeably herein.) One factor that limits the size of the inserter tube involves the material of the inserter tube itself. For example, the material from which the inserter tube is made, for example, polypropylene and similar polymeric materials, may not be compatible with or otherwise susceptible to causing the optics of IOLs, for example, made from silicone polymeric materials, to pass through relatively small hollow spaces. For example, the inserter tubes may be made of materials, in particular, polymeric materials, which have insufficient lubricity to facilitate the passage of a folded IOL through the tube. As a result of this lack of lubricity, the hollow space of the injector tube must be made relatively larger to accommodate the folded intraocular lens. This is detrimental since, as noted above, it is advantageous to have the smallest possible incision for insertion of the IOL. In addition, if one were to use a small diameter tube to pass the IOL, excessive force might be needed to pass the IOL through the small hollow space thereby increasing the risks of damaging the IOL and, in extreme cases, even damaging the eye into which the IOL is placed.

One approach that may be considered is to include a lubricity agent in a polymeric material to produce a compounded polymeric material of which the inserter tube is made. However, the lubricity agent is often chemically incompatible with the polymeric material and tends to be undesirably transferred to the IOL that is forced through the inserter tube. Excessive transfer of the lubricity agent to the IOL can result in a change in its optical properties.

Therefore, in general, it is advantageous to provide a method for preventing or at least for limiting the transfer of any additive from the polymeric material of a first article to a second polymeric article that is located adjacent to or that moves past the first article. In particular, it is very desirable to provide a method for preventing or at least for limiting the transfer of any additive in the polymeric material of the inserter to the IOL. It is also very desirable to provide an inserter that limits the transfer of material to the IOL as it passes through the inserter during use.

### SUMMARY

In general, the present invention provides a method for preventing or at least for limiting the transfer of an additive from a first polymeric article to a second polymeric article that is located adjacent to or that moves past the first article.

In one aspect, the additive and a polymeric material are compounded to form a compounded material that comprises the first article.

In another aspect, the method comprises subjecting the first polymeric article to a condition that transforms the additive into a substantially stable phase such that an amount of the additive transferred to the second polymeric article is reduced. The additive in a substantially stable phase means that the additive no longer undergoes a phase transformation when observed over a period of about one week.

In still another aspect, the method comprises heating the first polymeric article to a temperature in a range from about 27° C. to about 120° C., for a time in a range from about 10 minutes to about 26 weeks.

In yet another aspect, the additive comprises a surfactant. The term “surfactant” means a compound having a hydrophilic end and a hydrophobic end.

In a further aspect, the first polymeric article is an inserter for inserting an IOL into an eye, and the second polymeric article is the IOL.

In a still further aspect, the present invention provides an inserter for implanting an IOL into the eye, which inserter comprises a hollow tube that comprises a compounded polymeric material that comprises a major amount of a polymeric material and a minor amount of an additive. A portion of the inserter through which the IOL moves and is deformed has been heated prior to use to a temperature in a range from about 27° C. to about 100° C., for a time in a range from about 10 minutes to about 26 weeks.

Other features and advantages of the present invention will become apparent from the following detailed description and claims.

### BRIEF DESCRIPTION OF THE DRAWINGS

FIG. 1 is a perspective view of one type of inserter that can be treated in a method of the present invention.

FIG. 2 is a cross-sectional view of an eye illustrating the insertion and placement of an IOL into the eye.

FIG. 3 is a partial cross-sectional view of the tubular unit with the cover open and the cannula omitted.

FIG. 4 is a side elevational view of the plunger of the inserter of FIG. 1.

FIG. 5 is the top plan view of the plunger.

FIG. 6 is a cross-sectional view of the plunger along line 1-1.

FIG. 7 is a perspective view of a second type of inserter that can be treated in a method of the present invention.

FIG. 8 is a partial perspective view of the inserter of FIG. 7 with a compressor in a closed position.

FIG. 9 is a partial perspective view of the inserter of FIG. 7 with a compressor removed.

FIG. 10 is a partial perspective view of the inserter of FIG. 7 with an IOL at the free end of the inserter.

### DETAILED DESCRIPTION

In general, the present invention provides a method for preventing or at least for limiting the transfer of an additive from a first polymeric article to a second polymeric article that is located adjacent to or that moves past the first article.

In one aspect, the additive and a polymeric material are compounded to form a compounded material that comprises the first article.

In another aspect, the method comprises subjecting the first polymeric article to a condition that transforms the additive into a stable phase such that an amount of the additive transferred to the second polymeric article is reduced.

In still another aspect, the method comprises heating the first polymeric article to a temperature in a range from about 27° C. to about 100° C., for a time in a range from about 10 minutes to about 26 weeks. In one embodiment, the temperature range is from about 30° C. to about 80° C., or alternatively, from about 40° C. to about 60° C. In another embodiment, the heating step is carried out at a temperature in the range from about 40° C. to about 50° C. In still another embodiment, the heating step is carried out at about 45° C. In one aspect, the heating time is in an inverse relationship with the heating temperature; i.e., a higher heating temperature requires a shorter heating time.

In still another aspect, the heating is carried out stepwise, wherein the temperature is ramped up to one or more intermediate levels and held at each of the intermediate levels for a finite time. Alternatively, the temperature is ramped from the beginning temperature to the end temperature, and then held at the final temperature for a finite time. The total treatment time can be in the range from about 10 minutes to about 26 weeks, or from about 1 hour to about 14 weeks, or from about 24 hours to about 6 weeks, or from about 2 days to 2 weeks.

In yet another aspect, the additive comprises a surfactant. The surfactant can be a solid or liquid at normal processing temperature. A solid additive can be added, or otherwise mixed or blended, into the polymeric material to form a compounded polymeric material of which the first polymeric article comprises. Alternatively, a liquid additive can be added or otherwise mixed or blended, into a liquid or solid prepolymer. The mixture or blend of the two components can then be solidified, and the first polymeric material is formed from the solidified material.

The first polymeric article can be formed from the compounded polymeric material by any method of forming or shaping known in the art, such as molding, extruding, machining, or lathing.

In a further aspect, the first polymeric article is an inserter for inserting an IOL into an eye, and the second polymeric article is the IOL.

In a still further aspect, the present invention provides an inserter for implanting an IOL into the eye, which inserter comprises a hollow tube that comprises a compounded polymeric material that comprises a major amount of a polymeric material and a minor amount of an additive. Non-limiting examples of inserters that can be used in the practice of the present invention are disclosed below. At least a portion of the inserter through which the IOL moves and is deformed has been heated prior to use to a temperature in a range from about 27° C. to about 100° C., for a time in a range from about 10 minutes to about 26 weeks. Alternative temperature ranges and times are disclosed above. Alternatively, the whole inserter, without the IOL located therein, is heat treated before it is used to insert the IOL into the eye. In addition, before or after such a heat treatment, the inserter can be subjected to a sterilization procedure, such as exposure to ethylene oxide or irradiation. The heat treatment may be advantageously carried out soon after a part is made. Alternatively, a period of time may pass before the part is heat-treated according to the aforementioned disclosure.

The present invention is advantageously applicable to inserters of all types, wherein the IOL is folded and forced through a small passage for delivery into the eye. Several inserters are now described. However, it should be understood that the following description of inserters is only for illustrative purposes, and does not in any way limit the present invention.

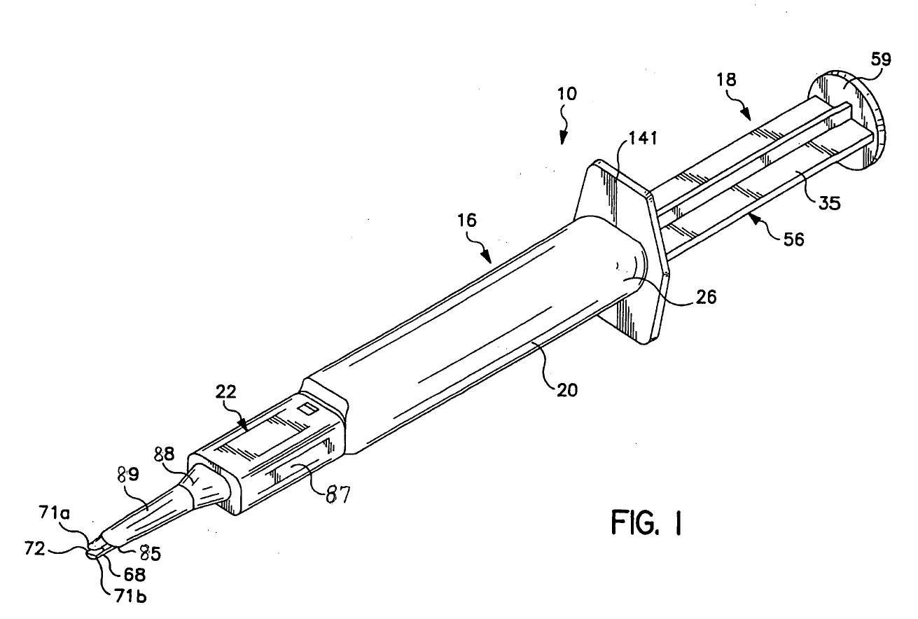

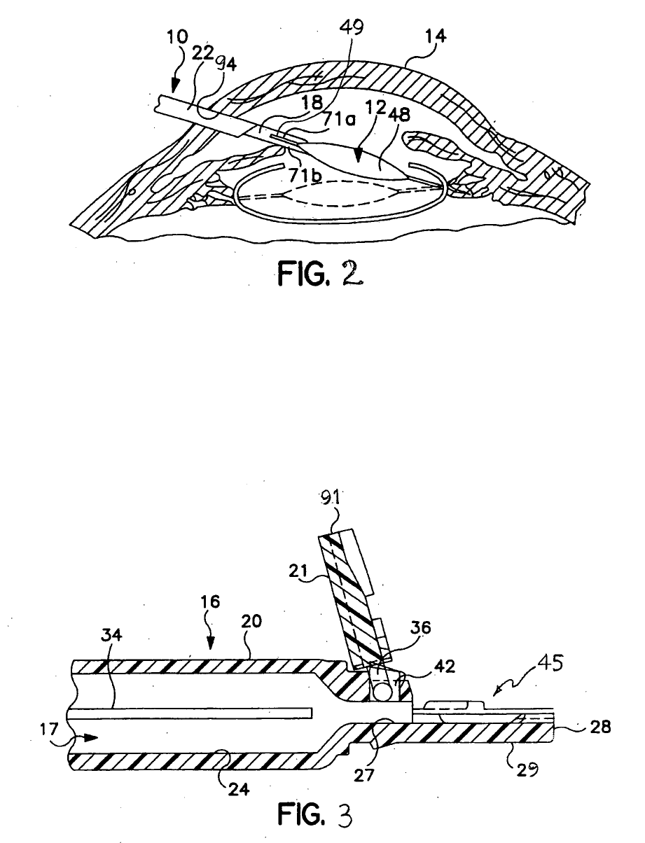

One such inserter is disclosed in U.S. Pat. No. 6,051,000, which is incorporated herein by reference in its entirety. In one embodiment, an inserter 10 for inserting a flexible membrane, such as a flexible IOL 12, into an eye 14 of a patient (FIGS. 1 and 2). Inserter 10 comprises a tubular member 16 having a passage 17 and a plunger 18 movably received within passage 17. Tubular member 16 preferably includes a base member 20, a cover 21, and a cannula 22 which are coupled together (FIGS. 1 and 3). The components of the device preferably comprise a polymeric material. Base member 20 is an elongate tubular element defining a passageway 24 which is provided with a relatively large opening at proximal end 26 and an opening 27 of reduced size near, but spaced from, distal end 28 (FIGS. 1 and 3). Passageway 24 of base member 20 is adapted to movably receive and guide plunger 18. A longitudinal groove 34 is preferably positioned along one of the side walls 32 of passageway 24 to receive a flange 35 of the plunger and prevent twisting of the plunger during use. A forwardly extending deck 29 projects beyond opening 27 to form a staging area 45 for initially receiving the lens. A cover 21 is pivotally attached to base member 20 and is movable between an open position to facilitate loading of a lens onto the deck, and a closed position where the cover overlies deck 29 and encloses the lens. Cover 21 preferably includes a pair of rearwardly extending arms 36 provided with knobs (not shown) on their free ends. The free ends of the arms 36 are fit into sockets 42 in base member 20 to form a hinge for the cover. Of course, other types of connections could be used to pivotally attach the cover for movement about either a longitudinal or transverse axis. The internal surfaces of deck 29 and cover 21 are configured to control the folding of the intraocular lens as the lens is advanced toward the eye. The shapes and functions of these surfaces are described in the above-noted U.S. Pat. No. 6,336,932, which is incorporated herein by reference.

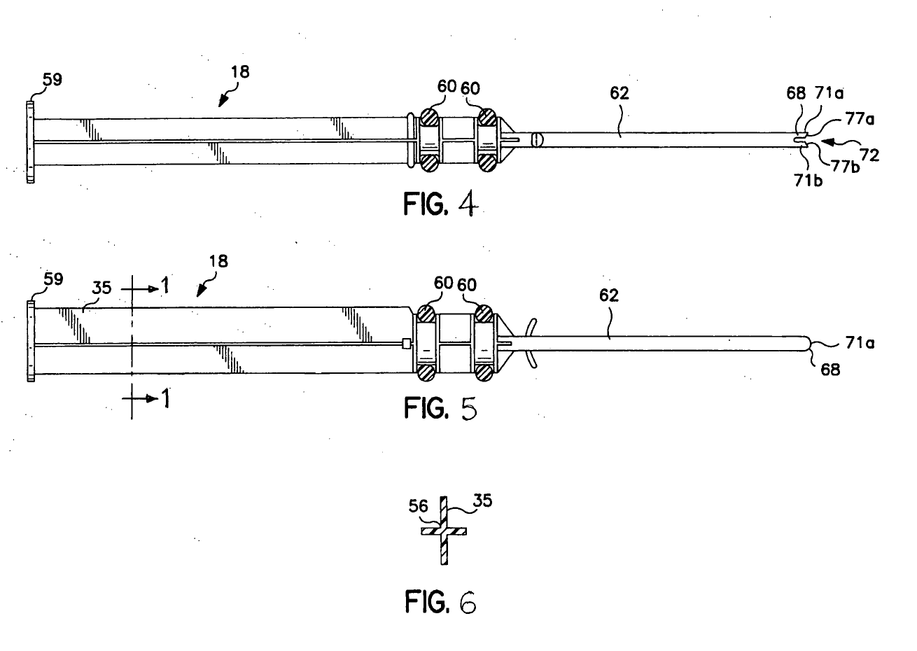

Plunger 18 is an elongate member which is adapted to move through passage 17 of tubular member 16 (FIGS. 1 and 4-6). FIGS. 4 and 5 illustrate two non-limiting plunger designs. Plunger 18 comprises a main body 56 preferably shaped with a cross-shaped cross section, although other constructions could be used. As discussed above, one flange 35 of the body is received into groove 34 (FIGS. 3-6). A flat thumb pad 59 is provided on the proximal end of body 56 for manual operation of the device (FIGS. 1, 4, and 5). Other constructions, however, may be provided to effect advancement of plunger 18 through tubular member 16. The forward end of body 56 includes a pair of spaced apart O-rings 60 (FIGS. 4 and 5). The O-rings provide a level of resistance to enable a more controlled manual operation of the plunger. The O-rings further help to prevent the plunger from inadvertent movement when the surgeon manipulates device 10 during the surgical procedure. Other constructions, such as friction fit flanges, may be used in place of the O-ring. A slender rod 62 projects forwardly beyond main body 56 of plunger 18 (FIGS. 4 and 5). Rod 62 engages the lens at staging area 45 and advances the lens into an eye. Distal tip 68 of rod 62 is preferably bifurcated to define a pair of prongs 71a, 71b separated by a slot 72 (FIG. 4). Slot 72 is shaped to receive and hold the proximal plate haptic 49 and optic 48 of IOL 12. The ends of prongs 71a, 71b are chamfered to form a pair of walls 77a, 77b, which collectively form a generally V-shaped configuration. Depending on the sturdiness of proximal haptic 49, walls 77a, 77b may or may not engage the proximal end of optic 48. Of course, distal tip 68 of plunger 18 may alternatively be formed with other structural configurations to engage the disclosed lens as well as other types of lenses (including lenses with loop haptics) when the lens is pushed toward the eye. Opening 27 adjacent staging area 45 preferably conforms closely to the size of rod 62.

Once IOL 12 has been properly loaded in staging area 45, a cannula 22 is fit over the cover 21 and deck 29 (FIG. 1). Cannula 22 is an elongate tubular member with an open proximal end and an opposite open distal end 85. Proximal section 87 of cannula 22 has a generally rectangular configuration which defines a cavity to matingly receive the assembled deck 29 and cover 21. Medial section 88 of cannula 22 is smaller than proximal section 87 so that a shoulder is placed in abutment with aligned distal ends 28 and 91 of deck 29 and cover 21. The inner wall of medial section 88 converges to define a funnel shaped passageway. This funnel-shaped section causes the lens to become substantially curled and compressed for entry into the eye. Distal section 89 of cannula 22 is a long, narrow tube which defines a lumen. Distal section 89 is adapted to be inserted through the narrow incision made in the eye.

To load the lens into inserter 10, cover 21 is opened to expose the staging area 45 on the upper side of deck 29. After the lens has been loaded onto deck 29, plunger 18 is advanced so that distal end 68 of plunger 18 engages IOL 12. Thereafter, cover 21 is closed and cannula 22 fit over deck 29 and cover 21. A viscoelastic material, typically used for such surgical procedures as a lubricant for the insertion process, is placed in cannula 22 prior to attachment of cannula 22 to the assembly.

In use, the surgeon inserts distal end 85 of cannula 22 into incision 94 in eye 14 (FIG. 2). The surgeon grasps lateral flanges 25 and pushes on pad 59 to move plunger 18 in a forward motion. Plunger 18 acts to push IOL 12 through open end 85 and beyond cannula 22. In the preferred construction, plunger 18 is pushed manually forward in a controlled manner, although other means, such as an electric motor or pneumatic drive, may be used.

The components of inserter 10, such as tubular member 16 including base member 20 and deck 29, plunger 18 including rod 62, cover 21, and cannula 22 are preferably made of a polymeric material, as described above. To facilitate the formation of the components and/or the movement of folded IOL 12 through the lumen of medial section 88 and distal section 89 of cannula 22, a small quantity of a surfactant is added or otherwise compounded into a base polymeric material. Non-limiting examples of suitable surfactants are the fatty acid monoesters and diesters of glycerol, such as glycerol monolaurate, glycerol monomyristate, glycerol monopalmitate, glycerol monostearate, glycerol monoarachidate, glycerol monobehenate, glycerol monopalmitoleate, glycerol monooleate, glycerol monolinoleate, glycerol monolinolenate, glycerol monoarachidonate, or combinations thereof. Non-limiting examples of diesters of glycerol are glycerol dilaurate, glycerol dimyristate, glycerol dipalmitate, glycerol distearate, glycerol diarachidate, glycerol dibehenate, glycerol dipalmitoleate, glycerol dioleate, glycerol dilinoleate, glycerol dilinolenate, glycerol diarachidonate, or combinations thereof. Other suitable surfactants are the fatty acids themselves, fatty acid esters of polyhydric alcohols, polyethylene glycol or polypropylene glycol having a range of molecular weights (such as from 2,000 to 100,000), or carbohydrate esters. The surfactant amount can be in the range from about 0.1 to about 5 weight percent (or from about 0.1 to about 2 weight percent, or from about 0.2 to about 1 weight percent) of the total compounded polymeric material.

The base polymeric material can be a homopolymer or a copolymer. Non-limiting examples of such polymers are polypropylene, polycarbonate, polysulfone, polymers or copolymers comprising fluoroethylene or fluoropropylene, and polyoxymethylene (POM). Non-limiting suitable polymers and copolymers comprising fluoroethylene, fluoropropylene, and/or other fluorohydrocarbons are polytetrafluoroethylene (PTFE), tetrafluoroethylene-hexafluoropropylene copolymer (FEP), ethylene-tetrafluoroethylene copolymer (ETFE), tetrafluoroethylene-perfluorovinylether copolymer (PFA), polyvinylidene fluoride (PVDF), polychlorotrifluoroethylene (PCTFE), ethylene-chlorotrifluoroethylene copolymer (ECTFE), and tetrafluoroethylene-perfluoro alkylvinyl ether copolymer (PFE). These polymers are commercially available.

In one aspect of the present invention, cannula 22 is heat treated, as is disclosed above, before the total assembly of inserter 10 is used for inserting IOL 12 into the eye of a patient. Alternatively, all the parts of the assembly may be heat treated, as is disclosed above.

Another type of inserter that can benefit from the present invention is disclosed in U.S. Pat. No. 5,944,725, which is incorporated herein by reference.

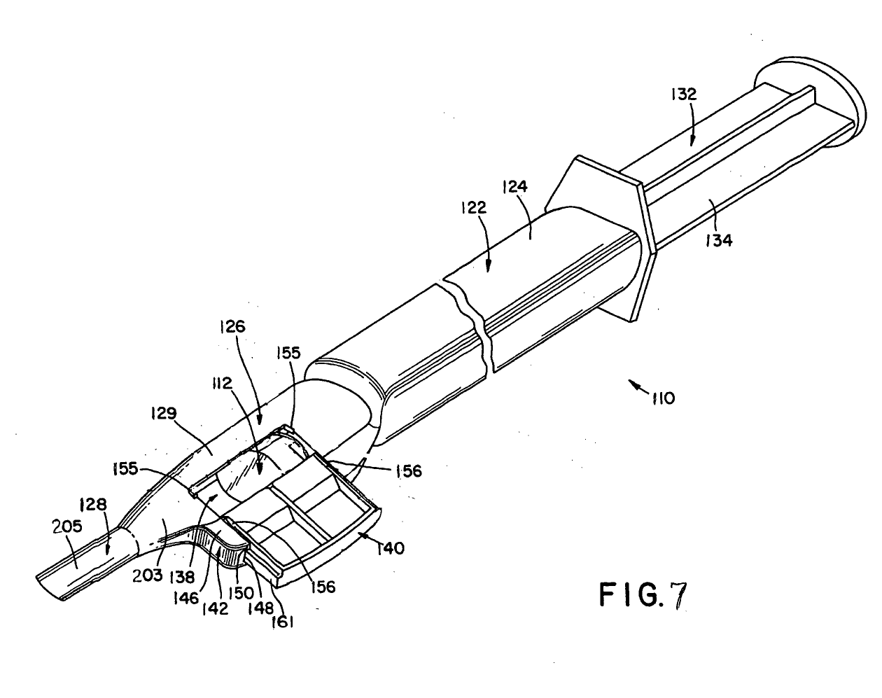

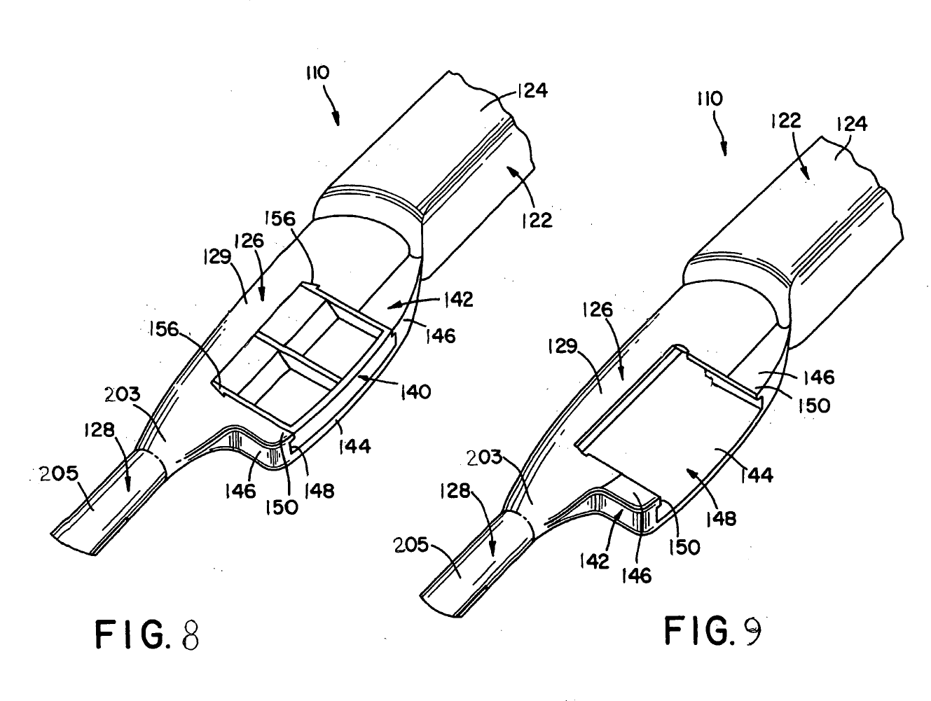

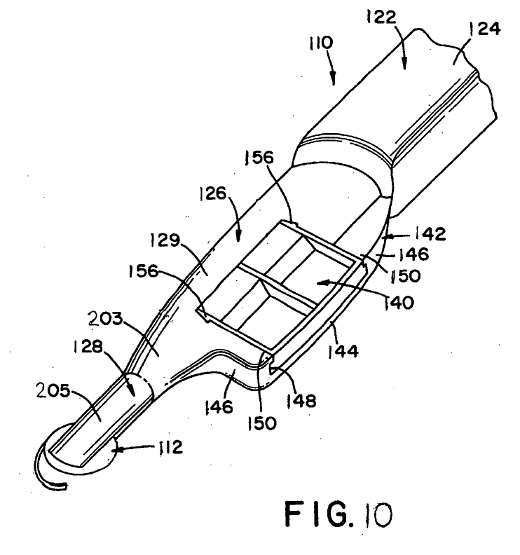

Inserter 110 includes a tubular member 122 for receiving and directing an IOL 112 into an eye (FIGS. 7-10). Tubular member 122 generally includes a body 124, a compressing station 126, and a cannula 128 (FIGS. 7-10). Body 124, cannula 128, and a support portion 129 of compressing station 126 are preferably formed as a unitary molded member from, for example, a compounded polymeric material, as disclosed above, although an integral assembly of plural parts could also be used. At the proximal end of member 122, body 124 forms a rearwardly opening passage which is adapted to receive a plunger 132 (FIG. 7). Plunger 132 includes a base 134 matingly received in body 124 and a shaft or rod (not shown), which extends forward to engage and push lens 112 into an eye. As is known in the industry, base 134 of plunger 132 is shaped to prevent rotation of the plunger relative to tubular member 122. For example, base 134 and the passage may have complementary non-circular shapes, or a key-and-keyway, or a tongue-and-groove construction. In addition, while plunger 132 is preferably advanced manually through body 124, a motor or other driving arrangement could be used to move the plunger.

Compressing station 126 includes an opening 138 in axial alignment with the passage of body 124 for receiving, compressing and directing lens 112 into cannula 128. Compressing station 126 includes a support 129 molded with body 124 and cannula 128, and a compressor 140 which is mounted for movement in support 129. Support 29 includes a generally U-shaped wing 142 provided with an elongate shelf 144 and a pair of arms 146. Arms 146 and shelf 144 collectively define a lateral channel or guideway 148 into which compressor 140 is moveably received. A lip 150 formed along the free end of each arm 146 retains compressor 140 against shelf 144 and thereby restricts the compressor to a lateral motion in channel 148. The inner end of each lip 150 defines a shoulder 155 over which a latch 156 from compressor 140 is received to lock compressor 140 in place for the operation. An additional abutting flange (not shown) or other known construction may also be included to prevent compressor 140 from being removed from channel 148.

Compressor 140 includes a pair of side faces 161 which are adapted to be matingly received within channel 148, and an inner sidewall (not shown) which is adapted to engage and compress IOL 112.

Compressor 140 is laterally movable between an open position and a closed position. In the open position, IOL 112 can be placed within compressing station 126 of tubular member 122 prior to shipment or by medical personnel at the time of surgery. In the closed position, compressor 40 is placed into channel 148 in opposed relation with a support portion 129. As compressor 140 is moved inward, IOL 112 begins to be compressed to a small cross section to be pushed through the lumen of cannula 128.

Cannula 128 projects forwardly from the distal end of compressing station 126 to direct IOL 112 into an eye. Cannula 128 preferably includes a proximal, funnel-shaped portion 203 which tapers to further compress the lens, and an elongate distal portion 205 which directs the compressed lens into an eye. Nevertheless, cannula 128 could be formed to have a uniform taper across its length or provided with no taper if, for example, compressor 140 has a longer stroke to complete the desired compression of the lens.

An interior lumen, which extends through cannula 128, is axially aligned with an internal passage of compressing station 126 to form a continuous duct through which IOL 112 is moved.

Distal portion 205 of cannula 128 is an elongate, slender tube to permit entry of inserter 110 through a narrow incision in the eye (not shown).

As is common with lens insertion procedures, a viscoelastic material or another lubricant material is injected into inserter 110 to ease the movement of IOL 112 into the eye. The lubricant can be injected into inserter 110 prior to closure of compressor 140 or it can be injected into an aperture through a side of compressor 140 if such a lubricant is to be injected after compressor 140 has been closed.

The components of inserter 110, such as tubular member 122 including body 124, compressing station 126, and support portion 129; plunger 132 including its shaft or rod; compressor 140; and cannula 128 are preferably made of a compounded polymeric material, as described above.

In one aspect of the present invention, cannula 128 is heat treated, as is disclosed above, before the total assembly of inserter 110 is used for inserting IOL 112 into the eye of a patient. Alternatively, all the parts of the assembly may be heat treated, as is disclosed above.

Still another type of inserter that can benefit from the present invention is disclosed in U.S. Pat. No. 6,679,891, which is incorporated herein by reference. The inserter including the load chamber and its hinged members and the injection tube can be made of a polymeric composition that includes an additive and can be treated according to a method of the present invention, as is disclosed above.

### EXAMPLE 1

Components of inserters of the type illustrated in FIGS. 1 and 3-6 were made from a compounded material comprising polypropylene and glycerol monostearate (about 1 weight percent of the compounded material). A batch of cannulas was heat-treated at about 45° C. in a forced-convection oven. Another batch of cannulas was not heat-treated but subjected to a sterilization procedure at 50° C. for 24 hours (with or without exposure to ethylene oxide (“EO”)), to serve as control samples. Heat-treated cannulas were removed from the oven on day 3, 6, and 7, and complete inserters were assembled with these and untreated cannulas. The completely assembled inserters were tested for the transfer of the additive material from the cannulas to Adapt™ IOLs (Bausch and Lomb Incorporated, Rochester, N.Y.) after they were forced through the cannulas with the aid of Amvisc Plus™ viscoelastic material (Bausch and Lomb Incorporated, Rochester, N.Y.) disposed in the cannulas. Each IOL, after passing through the cannula, was observed for the level of transferred additive (low (L), medium (M), or high (H)) and location of the additive (outside the central optic (O) or inside the central optic (I)).

Tables 1 and 2 show the observations of IOLs for the tests with the control and heat-treated cannulas, respectively. A comparison of the observations shows that cannulas that were heat-treated at 45° C. for 3 or 7 days transferred much reduced quantities of the additive to the IOLs.

TABLE 1
Results of Testing of Control Cannulas

| | Lens Power | Treatment | Amount of | Location of |
|---|---|---|---|---|
| Lens No. | (diopters) | Method | Additive | Additive |
| 1 | +19.0 | EO, 50° C., 24 hr | H | I |
| 2 | +19.0 | EO, 50° C., 24 hr | H | I |
| 3 | +19.0 | EO, 50° C., 24 hr | M | I |
| 4 | +21.0 | EO, 50° C., 24 hr | H | I |
| 5 | +21.0 | EO, 50° C., 24 hr | H | I |
| 6 | +21.0 | EO, 50° C., 24 hr | H | I |
| 7 | +29.0 | EO, 50° C., 24 hr | H | I |
| 8 | +29.0 | EO, 50° C., 24 hr | H | I |
| 9 | +29.0 | EO, 50° C., 24 hr | H | I |
| 10 | +30.0 | EO, 50° C., 24 hr | H | I |
| 11 | +30.0 | EO, 50° C., 24 hr | H | I |
| 12 | +20.0 | 50° C., 24 hr | M | I |
| 13 | +20.0 | 50° C., 24 hr | M | I |
| 14 | +20.0 | 50° C., 24 hr | H | I |
| 15 | +20.0 | 50° C., 24 hr | H | I |
| 16 | +20.0 | 50° C., 24 hr | M | I |
| 17 | +30.0 | 50° C., 24 hr | H | I |
| 18 | +30.0 | 50° C., 24 hr | H | I |
| 19 | +30.0 | 50° C., 24 hr | H | I |
| 20 | +30.0 | 50° C., 24 hr | H | I |
| 21 | +30.0 | 50° C., 24 hr | H | I |

TABLE 2
Results of Testing of Heat-Treated Cannulas

| | Lens Power | Treatment | Amount of | Location of |
|---|---|---|---|---|
| Lens No. | (diopters) | Method | Additive | Additive |
| 1 | +18.5 | 45° C., 3 days | L | O |
| 2 | +20.0 | 45° C., 3 days | L | O |
| 3 | +20.0 | 45° C., 3 days | L | O |
| 4 | +20.5 | 45° C., 3 days | L | I |
| 5 | +21.0 | 45° C., 3 days | L | O |
| 6 | +29.0 | 45° C., 3 days | L | O |
| 7 | +29.0 | 45° C., 3 days | M | O |
| 8 | +29.0 | 45° C., 3 days | M | I |
| 9 | +29.5 | 45° C., 3 days | L | O |
| 10 | +30.0 | 45° C., 3 days | L | O |
| 11 | +18.5 | 45° C., 3 days | none | no data |
| 12 | +20.0 | 45° C., 3 days | L | O |
| 13 | +20.0 | 45° C., 3 days | L | O |
| 14 | +20.5 | 45° C., 3 days | L | O |
| 15 | +21.0 | 45° C., 3 days | L | O |
| 16 | +29.0 | 45° C., 3 days | L | I |
| 17 | +29.0 | 45° C., 3 days | L | I |
| 18 | +29.0 | 45° C., 3 days | M | O |
| 19 | +29.5 | 45° C., 3 days | L | I |
| 20 | +30.0 | 45° C., 3 days | M | I |
| 21 | +18.0 | 45° C., 6 days | L | I |
| 22 | +20.0 | 45° C., 6 days | M | I |
| 23 | +20.0 | 45° C., 6 days | none | no data |
| 24 | +20.5 | 45° C., 6 days | none | no data |
| 25 | +21.0 | 45° C., 6 days | none | no data |
| 26 | +29.0 | 45° C., 6 days | L | O |
| 27 | +29.0 | 45° C., 6 days | L | I |
| 28 | +29.0 | 45° C., 6 days | L | O |
| 29 | +29.5 | 45° C., 6 days | none | no data |
| 30 | +30.0 | 45° C., 6 days | L | O |
| 31 | +18.0 | 45° C., 6 days | none | no data |
| 32 | +20.0 | 45° C., 6 days | L | O |
| 33 | +20.0 | 45° C., 6 days | none | no data |
| 34 | +20.5 | 45° C., 6 days | none | no data |
| 35 | +21.0 | 45° C., 6 days | none | no data |
| 36 | +29.0 | 45° C., 6 days | L | O |
| 37 | +29.0 | 45° C., 6 days | none | no data |
| 38 | +29.0 | 45° C., 6 days | L | O |
| 39 | +29.5 | 45° C., 6 days | L | O |
| 40 | +30.0 | 45° C., 6 days | L | O |
| 41 | +18.0 | 45° C., 7 days | none | no data |
| 42 | +20.0 | 45° C., 7 days | none | no data |
| 43 | +20.0 | 45° C., 7 days | none | no data |
| 44 | +20.5 | 45° C., 7 days | none | no data |
| 45 | +21.0 | 45° C., 7 days | L | O |
| 46 | +29.0 | 45° C., 7 days | none | no data |
| 47 | +29.0 | 45° C., 7 days | none | no data |
| 48 | +29.0 | 45° C., 7 days | L | O |
| 49 | +29.5 | 45° C., 7 days | L | O |
| 50 | +30.0 | 45° C., 7 days | none | no data |
| 51 | +18.0 | 45° C., 7 days | none | no data |
| 52 | +20.0 | 45° C., 7 days | L | O |
| 53 | +20.0 | 45° C., 7 days | L | O |
| 54 | +20.5 | 45° C., 7 days | none | no data |
| 55 | +21.0 | 45° C., 7 days | none | no data |
| 56 | +29.0 | 45° C., 7 days | L | O |
| 57 | +29.0 | 45° C., 7 days | none | no data |
| 58 | +29.0 | 45° C., 7 days | L | O |
| 59 | +29.5 | 45° C., 7 days | none | no data |
| 60 | +30.0 | 45° C., 7 days | L | O |

### EXAMPLE 2

Components of inserters of the type illustrated in FIGS. 1 and 3-6 were made from a compounded material comprising polypropylene and glycerol monostearate (about 1 weight percent of the compounded material). The components were subjected to a sterilization procedure using EO at 50° C. for 24 hours. Sterilized cannulas were allowed to age naturally at room temperature (control samples). Some cannulas were heat-treated at 45° C. for 3 and 7 days in a forced-convection oven after natural aging for 5 weeks. Other cannulas were heat-treated at 45° C. for 7 or 14 days in a forced-convection oven after natural aging for 8 weeks. Complete inserters were assembled with heat-treated and naturally aged cannulas of approximately same age and tested for the delivery of Adapt AO™ IOLs (Bausch and Lomb Incorporated, Rochester, N.Y.) with the aid of Amvisc Plus™ viscoelastic material (Bausch and Lomb Incorporated, Rochester, N.Y.) disposed in the cannula. Each IOL, after passing through the cannula, was observed for the level of the transferred additive (low (L), medium (M), or high (H)) and location of the additive (outside the central optic (O) or inside the central optic (I)).

Tables 3 and 4 show the observations of IOLs for the tests with the control (naturally aged for 6 weeks) and heat-treated cannulas (naturally aged for 5 weeks and heat treated for 3 or 7 days), respectively. A comparison of the observations shows that cannulas that were heat treated at 45° C. for 3 or 7 days transferred much reduced quantities of additive to the IOLs.

TABLE 3
Results of Testing of Control Cannulas (Naturally Aged for 6 Weeks)

| | Lens Power | Treatment | Amount of | Location of |
|---|---|---|---|---|
| Lens No. | (diopters) | Method | Additive | Additive |
| 1 | +20.0 | EO, 50° C., 24 hr | L | O |
| 2 | +20.0 | EO, 50° C., 24 hr | L | O |
| 3 | +20.0 | EO, 50° C., 24 hr | H | O |
| 4 | +20.0 | EO, 50° C., 24 hr | L | I |
| 5 | +30.0 | EO, 50° C., 24 hr | M | O |
| 6 | +30.0 | EO, 50° C., 24 hr | H | I |
| 7 | +30.0 | EO, 50° C., 24 hr | H | O |

TABLE 4
Results of Testing of Heat-Treated
Cannulas After Natural Aging for 5 Weeks

| | Lens Power | Treatment | Amount of | Location of |
|---|---|---|---|---|
| Lens No. | (diopters) | Method | Additive | Additive |
| 1 | +20.0 | 45° C., 3 days | none | no data |
| 2 | +20.0 | 45° C., 3 days | none | no data |
| 3 | +20.0 | 45° C., 3 days | L | O |
| 4 | +20.0 | 45° C., 3 days | L | O |
| 5 | +20.0 | 45° C., 3 days | L | O |
| 6 | +30.0 | 45° C., 3 days | L | O |
| 7 | +30.0 | 45° C., 3 days | L | O |
| 8 | +30.0 | 45° C., 3 days | L | O |
| 9 | +20.5 | 45° C., 3 days | M | O |
| 10 | +30.0 | 45° C., 3 days | L | O |
| 11 | +20.0 | 45° C., 7 days | L | I |
| 12 | +20.0 | 45° C., 7 days | none | no data |
| 13 | +20.0 | 45° C., 7 days | none | no data |
| 14 | +20.0 | 45° C., 7 days | L | O |
| 15 | +20.0 | 45° C., 7 days | L | O |
| 16 | +30.0 | 45° C., 7 days | L | O |
| 17 | +30.0 | 45° C., 7 days | none | no data |
| 18 | +30.0 | 45° C., 7 days | none | no data |
| 19 | +30.0 | 45° C., 7 days | L | O |
| 20 | +30.0 | 45° C., 7 days | none | no data |

Tables 5 and 6 show the observations of IOLs for the tests with the control (naturally aged for 8 weeks) and heat-treated cannulas (naturally aged for 10 weeks and heat treated for 7 or 14 days), respectively. A comparison of the observations shows that cannulas that were heat treated at 45° C. for 7 or 14 days transferred much reduced quantities of additive to the IOLs.

TABLE 5
Results of Testing of Control Cannulas (Naturally Aged for 10 Weeks)

| | Lens Power | Treatment | Amount of | Location of |
|---|---|---|---|---|
| Lens No. | (diopters) | Method | Additive | Additive |
| 1 | +10.0 | EO, 50° C., 24 hr | none | no data |
| 2 | +10.0 | EO, 50° C., 24 hr | L | I |
| 3 | +10.0 | EO, 50° C., 24 hr | none | no data |
| 4 | +10.0 | EO, 50° C., 24 hr | L | O |
| 5 | +10.0 | EO, 50° C., 24 hr | L | I |
| 6 | +20.0 | EO, 50° C., 24 hr | M | I |
| 7 | +20.0 | EO, 50° C., 24 hr | M | I |
| 8 | +20.0 | EO, 50° C., 24 hr | H | O |
| 9 | +20.0 | EO, 50° C., 24 hr | L | I |
| 10 | +20.0 | EO, 50° C., 24 hr | H | I |
| 11 | +30.0 | EO, 50° C., 24 hr | L | O |
| 12 | +30.0 | EO, 50° C., 24 hr | H | I |
| 13 | +30.0 | EO, 50° C., 24 hr | M | O |
| 14 | +30.0 | EO, 50° C., 24 hr | M | I |
| 15 | +30.0 | EO, 50° C., 24 hr | H | I |

TABLE 6
Results of Testing of Heat-Treated
Cannulas After Natural Aging for 8 Weeks

| | Lens Power | Treatment | Amount of | Location of |
|---|---|---|---|---|
| Lens No. | (diopters) | Method | Additive | Additive |
| 1 | +10.0 | 45° C., 7 days | none | no data |
| 2 | +10.0 | 45° C., 7 days | none | no data |
| 3 | +10.0 | 45° C., 7 days | none | no data |
| 4 | +10.0 | 45° C., 7 days | none | no data |
| 5 | +10.0 | 45° C., 7 days | L | I |
| 6 | +20.0 | 45° C., 7 days | L | O |
| 7 | +20.0 | 45° C., 7 days | none | no data |
| 8 | +20.0 | 45° C., 7 days | none | no data |
| 9 | +20.0 | 45° C., 7 days | L | O |
| 10 | +20.0 | 45° C., 7 days | none | no data |
| 11 | +30.0 | 45° C., 7 days | L | O |
| 12 | +30.0 | 45° C., 7 days | none | no data |
| 13 | +30.0 | 45° C., 7 days | L | O |
| 14 | +30.0 | 45° C., 7 days | L | O |
| 15 | +30.0 | 45° C., 7 days | M | O |
| 16 | +10.0 | 45° C., 14 days | none | no data |
| 17 | +10.0 | 45° C., 14 days | none | no data |
| 18 | +10.0 | 45° C., 14 days | none | no data |
| 19 | +10.0 | 45° C., 14 days | L | O |
| 20 | +10.0 | 45° C., 14 days | none | no data |
| 21 | +20.0 | 45° C., 14 days | none | no data |
| 22 | +20.0 | 45° C., 14 days | none | no data |
| 23 | +20.0 | 45° C., 14 days | L | O |
| 24 | +20.0 | 45° C., 14 days | L | O |
| 25 | +20.0 | 45° C., 14 days | none | no data |
| 26 | +30.0 | 45° C., 14 days | L | O |
| 27 | +30.0 | 45° C., 14 days | none | no data |
| 28 | +30.0 | 45° C., 14 days | L | O |
| 29 | +30.0 | 45° C., 14 days | none | no data |
| 30 | +30.0 | 45° C., 14 days | L | O |
| 31 | +10.0 | 45° C., 14 days | none | no data |
| 32 | +10.0 | 45° C., 14 days | L | O |
| 33 | +10.0 | 45° C., 14 days | L | O |
| 34 | +10.0 | 45° C., 14 days | none | no data |
| 35 | +10.0 | 45° C., 14 days | none | no data |
| 36 | +20.0 | 45° C., 14 days | L | O |
| 37 | +20.0 | 45° C., 14 days | L | O |
| 38 | +20.0 | 45° C., 14 days | none | no data |
| 39 | +20.0 | 45° C., 14 days | none | no data |
| 40 | +30.0 | 45° C., 14 days | L | O |
| 41 | +30.0 | 45° C., 14 days | L | O |
| 42 | +30.0 | 45° C., 14 days | L | O |
| 43 | +30.0 | 45° C., 14 days | L | O |
| 44 | +30.0 | 45° C., 14 days | L | O |
| 45 | +30.0 | 45° C., 14 days | L | O |

### EXAMPLE 3

Inserter components were made as disclosed in Example 2. Cannulas were heat-treated at 45° C. for 7 days substantially immediately after they were made and then sterilized with EO at 50° C. for 24 hours. Complete inserters were tested as in Example 2, and the results of the testing are shown in Table 7. Again, the amounts of transferred additive were observed to be much reduced.

TABLE 7
Results of Testing of Cannulas Heat-Treated Then EO-Sterilized

| | Lens Power | Treatment | Amount of | Location of |
|---|---|---|---|---|
| Lens No. | (diopters) | Method | Additive | Additive |
| 1 | +10.0 | 45° C., 7 days | L | O |
| 2 | +10.0 | 45° C., 7 days | L | O |
| 3 | +10.0 | 45° C., 7 days | L | O |
| 4 | +10.0 | 45° C., 7 days | L | O |
| 5 | +10.0 | 45° C., 7 days | L | O |
| 6 | +20.0 | 45° C., 7 days | L | O |
| 7 | +20.0 | 45° C., 7 days | L | O |
| 8 | +20.0 | 45° C., 7 days | L | O |
| 9 | +20.0 | 45° C., 7 days | L | O |
| 10 | +20.0 | 45° C., 7 days | L | O |
| 11 | +30.0 | 45° C., 7 days | L | O |
| 12 | +30.0 | 45° C., 7 days | L | O |
| 13 | +30.0 | 45° C., 7 days | L | O |
| 14 | +30.0 | 45° C., 7 days | L | O |
| 15 | +30.0 | 45° C., 7 days | none | no data |

PARTS LIST

| Part No. | Description |
|---|---|
| 10 | inserter |
| 12 | IOL |
| 14 | eye |
| 16 | tubular member |
| 17 | passage |
| 18 | plunger |
| 20 | base member |
| 21 | cover |
| 22 | cannula |
| 24 | passageway |
| 25 | lateral flange of base member 20 |
| 26 | proximal end of tubular member 16 |
| 27 | distal opening of tubular member 16 |
| 28 | distal end of base member 20 |
| 29 | deck |
| 34 | longitudinal groove |
| 35 | flange |
| 36 | arms of cover 21 |
| 42 | sockets |
| 45 | staging area |
| 48 | optic |
| 49 | haptic |
| 59 | thumb pad |
| 60 | O-ring |
| 62 | slender rod |
| 68 | distal tip of rod 62 |
| 71a, 71b | prongs |
| 72 | slot |
| 77a, 77b | walls |
| 85 | open distal end |
| 87 | proximal section of cannula 22 |
| 88 | medial section of cannula 22 |
| 89 | distal section of cannula 22 |
| 91 | distal end of cover 21 |
| 94 | incision in eye |
| 110 | inserter |
| 112 | IOL |
| 122 | tubular member |
| 124 | body |
| 126 | compressing station |
| 128 | cannula |
| 129 | support portion |
| 132 | plunger |
| 134 | plunger base |
| 138 | opening of compressing station 126 |
| 140 | compressor |
| 142 | wings |
| 144 | shelf |
| 146 | arms |
| 148 | guideway |
| 150 | lip |
| 155 | shoulder |
| 156 | latch |
| 161 | side faces |
| 203 | funnel-shaped portion of cannula 128 |
| 205 | elongate distal portion of cannula 128 |

While specific embodiments of the present invention have been described in the foregoing, it will be appreciated by those skilled in the art that many equivalents, modifications, substitutions, and variations may be made thereto without departing from the spirit and scope of the invention as defined in the appended claims.

What is claimed is:

1. A method for limiting a transfer of an additive from a first polymeric article to a second polymeric article, the method comprising treating at least a portion of the first polymeric article under a condition such that the additive is transformed to a substantially stable phase, wherein the second polymeric material is disposed adjacent to said portion during use.

2. The method of claim 1, wherein said treating comprises heating at a temperature in a range from about 27° C. to about 120° C., for a time from about 10 minutes to about 26 weeks.

3. The method of claim 1, wherein said treating comprises heating at a temperature in a range from about 27° C. to about 100° C.

4. The method of claim 1, wherein said treating comprises heating at a temperature in a range from about 30° C. to about 80° C.

5. The method of claim 1, wherein said treating comprises heating at a temperature in a range from about 40° C. to about 60° C.

6. The method of claim 1, wherein said treating comprises heating at a temperature of about 45° C.

7. The method of claim 1, wherein said time is in a range from about 1 hour to about 14 weeks.

8. The method of claim 1, wherein said time is in a range from about 2 days to about 2 weeks.

9. The method of claim 6, wherein said time is in a range from about 2 days to about 2 weeks.

10. The method of claim 1, wherein the first polymeric article comprises a compounded polymeric material that comprises the additive compounded in a base polymeric material.

11. The method of claim 10, wherein the additive is a surfactant selected from the group consisting of fatty acid monoesters of glycerol, fatty acid diesters of glycerol, fatty acid esters of polyhydric alcohols, polyethylene glycol, polypropylene glycol, and combinations thereof.

12. The method of claim 11, wherein the surfactant is selected from the group consisting of glycerol monolaurate, glycerol monomyristate, glycerol monopalmitate, glycerol monostearate, glycerol monoarachidate, glycerol monobehenate, glycerol monopalmitoleate, glycerol monooleate, glycerol monolinoleate, glycerol monolinolenate, glycerol monoarachidonate, glycerol dilaurate, glycerol dimyristate, glycerol dipalmitate, glycerol distearate, glycerol diarachidate, glycerol dibehenate, glycerol dipalmitoleate, glycerol dioleate, glycerol dilinoleate, glycerol dilinolenate, glycerol diarachidonate, and combinations thereof.

13. The method of claim 10, wherein the base polymeric material is selected from the group consisting of polypropylene, polycarbonate, polysulfone, polymers or copolymers comprising fluoroethylene or fluoropropylene, and polyoxymethylene (POM), polytetrafluoroethylene (PTFE), tetrafluoroethylene-hexafluoropropylene copolymer (FEP), ethylene-tetrafluoroethylene copolymer (ETFE), tetrafluoroethylene-perfluorovinylether copolymer (PFA), polyvinylidene fluoride (PVDF), polychlorotrifluoroethylene (PCTFE), ethylene-chlorotrifluoroethylene copolymer (ECTFE), tetrafluoroethylene-perfluoro alkylvinyl ether copolymer (PFE), and combinations thereof.

14. The method of claim 12, wherein the base polymeric material is selected from the group consisting of polypropylene, polycarbonate, polysulfone, polymers or copolymers comprising fluoroethylene or fluoropropylene, and polyoxymethylene (POM), polytetrafluoroethylene (PTFE), tetrafluoroethylene-hexafluoropropylene copolymer (FEP), ethylene-tetrafluoroethylene copolymer (ETFE), tetrafluoroethylene-perfluorovinylether copolymer (PFA), polyvinylidene fluoride (PVDF), polychlorotrifluoroethylene (PCTFE), ethylene-chlorotrifluoroethylene copolymer (ECTFE), tetrafluoroethylene-perfluoro alkylvinyl ether copolymer (PFE), and combinations thereof.

15. The method of claim 14, wherein the first article is an inserter for implanting an intraocular lens (“IOL”) in an eye and the second article is the IOL.

16. The method of claim 1, wherein said treating is carried out after said portion is exposed to ambient temperature for a period of time.

17. The method of claim 1, wherein said treating is carried out substantially immediately after said portion is formed.

18. A polymeric article comprising a portion through which other polymeric article moves, wherein said portion comprises a compounded polymeric material that comprises a surfactant included in a base polymeric material, and said surfactant exists in a substantially stable phase.

19. The polymeric article of claim 18, wherein said surfactant is selected from the group consisting of fatty acid monoesters of glycerol, fatty acid diesters of glycerol, fatty acid esters of polyhydric alcohols, polyethylene glycol, polypropylene glycol, and combinations thereof.

20. The polymeric article of claim 19, wherein the surfactant is selected from the group consisting of glycerol monolaurate, glycerol monomyristate, glycerol monopalmitate, glycerol monostearate, glycerol monoarachidate, glycerol monobehenate, glycerol monopalmitoleate, glycerol monooleate, glycerol monolinoleate, glycerol monolinolenate, glycerol monoarachidonate, glycerol dilaurate, glycerol dimyristate, glycerol dipalmitate, glycerol distearate, glycerol diarachidate, glycerol dibehenate, glycerol dipalmitoleate, glycerol dioleate, glycerol dilinoleate, glycerol dilinolenate, glycerol diarachidonate, and combinations thereof.

21. The polymeric article of claim 19, wherein the base polymeric material is selected from the group consisting of polypropylene, polycarbonate, polysulfone, polymers or copolymers comprising fluoroethylene or fluoropropylene, and polyoxymethylene (POM), polytetrafluoroethylene (PTFE), tetrafluoroethylene-hexafluoropropylene copolymer (FEP), ethylene-tetrafluoroethylene copolymer (ETFE), tetrafluoroethylene-perfluorovinylether copolymer (PFA), polyvinylidene fluoride (PVDF), polychlorotrifluoroethylene (PCTFE), ethylene-chlorotrifluoroethylene copolymer (ECTFE), tetrafluoroethylene-perfluoro alkylvinyl ether copolymer (PFE), and combinations thereof.

22. The polymeric article of claim 20, wherein the base polymeric material is selected from the group consisting of polypropylene, polycarbonate, polysulfone, polymers or copolymers comprising fluoroethylene or fluoropropylene, and polyoxymethylene (POM), polytetrafluoroethylene (PTFE), tetrafluoroethylene-hexafluoropropylene copolymer (FEP), ethylene-tetrafluoroethylene copolymer (ETFE), tetrafluoroethylene-perfluorovinylether copolymer (PFA), polyvinylidene fluoride (PVDF), polychlorotrifluoroethylene (PCTFE), ethylene-chlorotrifluoroethylene copolymer (ECTFE), tetrafluoroethylene-perfluoro alkylvinyl ether copolymer (PFE), and combinations thereof.

23. The polymeric article of claim 22, wherein said polymeric article is an inserter for implanting an IOL in an eye and said another polymeric article is the IOL.

24. The polymeric article of claim 23, wherein a cross section of a lumen of said portion decreases in a direction of a movement of said IOL.

25. The polymeric article of claim 24, wherein said portion is heat-treated at a temperature in a range from about 27° C. to about 120° C., for a time from about 10 minutes to about 26 weeks.

26. The polymeric article of claim 24, wherein said portion is heat-treated at a temperature in a range from about 30° C. to about 80° C., for a time from about 1 hour to about 2 weeks.

27. The polymeric article of claim 24, wherein said portion is heat-treated at a temperature of about 45° C. for a time from about 1 hour to about 2 weeks.

28. A method for producing a polymeric article, the method comprising:
(a) forming the article from a compounded polymeric material that comprises a surfactant included in a base polymeric material; and
(b) treating at least a portion of the article under a condition such that the surfactant is transformed to a substantially stable phase.

29. The method of claim 28, wherein said treating comprises heating at a temperature in a range from about 27° C. to about 120° C., for a time from about 10 minutes to about 26 weeks.

30. The method of claim 28, wherein said treating comprises heating at a temperature in a range from about 30° C. to about 80° C.

31. The method of claim 28, wherein said treating comprises heating at a temperature in a range from about 40° C. to about 60° C.

32. The method of claim 28, wherein said treating comprises heating at a temperature of about 45° C.

33. The method of claim 28, wherein said time is in a range from about 1 hour to about 14 weeks.

34. The method of claim 28, wherein said time is in a range from about 2 days to about 2 weeks.

35. The method of claim 31, wherein said time is in a range from about 2 days to about 2 weeks.

36. The method of claim 35, wherein the additive is a surfactant selected from the group consisting of fatty acid monoesters of glycerol, fatty acid diesters of glycerol, fatty acid esters of polyhydric alcohols, polyethylene glycol, polypropylene glycol, and combinations thereof.

37. The method of claim 36, wherein the surfactant is selected from the group consisting of glycerol monolaurate, glycerol monomyristate, glycerol monopalmitate, glycerol monostearate, glycerol monoarachidate, glycerol monobehenate, glycerol monopalmitoleate, glycerol monooleate, glycerol monolinoleate, glycerol monolinolenate, glycerol monoarachidonate, glycerol dilaurate, glycerol dimyristate, glycerol dipalmitate, glycerol distearate, glycerol diarachidate, glycerol dibehenate, glycerol dipalmitoleate, glycerol dioleate, glycerol dilinoleate, glycerol dilinolenate, glycerol diarachidonate, and combinations thereof.

38. The method of claim 36, wherein the base polymeric material is selected from the group consisting of polypropylene, polycarbonate, polysulfone, polymers or copolymers comprising fluoroethylene or fluoropropylene, and polyoxymethylene (POM), polytetrafluoroethylene (PTFE), tetrafluoroethylene-hexafluoropropylene copolymer (FEP), ethylene-tetrafluoroethylene copolymer (ETFE), tetrafluoroethylene-perfluorovinylether copolymer (PFA), polyvinylidene fluoride (PVDF), polychlorotrifluoroethylene (PCTFE), ethylene-chlorotrifluoroethylene copolymer (ECTFE), tetrafluoroethylene-perfluoro alkylvinyl ether copolymer (PFE), and combinations thereof.

39. The method of claim 37, wherein the base polymeric material is selected from the group consisting of polypropylene, polycarbonate, polysulfone, polymers or copolymers comprising fluoroethylene or fluoropropylene, and polyoxymethylene (POM), polytetrafluoroethylene (PTFE), tetrafluoroethylene-hexafluoropropylene copolymer (FEP), ethylene-tetrafluoroethylene copolymer (ETFE), tetrafluoroethylene-perfluorovinylether copolymer (PFA), polyvinylidene fluoride (PVDF), polychlorotrifluoroethylene (PCTFE), ethylene-chlorotrifluoroethylene copolymer (ECTFE), tetrafluoroethylene-perfluoro alkylvinyl ether copolymer (PFE), and combinations thereof.
